(19) United States
(12) Patent Application Publication
(10) Pub. No.: US 2008/0045128 A1
(43) Pub. Date: Feb. 21, 2008

(54) Door skin cutter

(76) Inventors: Gerald D. Trueit, Redondo Beach, CA (US); David Kilburn, Garden Grove, CA (US)

Correspondence Address: PATENT LAW & VENTURE GROUP, 2424 S.E. BRISTOL, SUITE 300, NEWPORT BEACH, CA, 92660, US

(21) Appl. No.: 11/506,657

(22) Filed: Aug. 17, 2006

(51) Int. Cl. B24B 27/08; B23C 1/20

(52) U.S. Cl. 451/358; 409/180

(57) ABSTRACT

A cutter apparatus is configured for cutting into an edge of a metal sheet and for adjusting a precise depth of cut. A motor drives a cutting tool, preferably a rotary file, in axial rotation. A guide plate supports the motor with the cutting tool extending through a hole in the guide plate. A guide bar is fixed to the guide plate and the guide bar presents a guide bar surface which is orthogonal to a guide plate surface so that when the edge of the metal sheet is pressed against the guide bar surface with the metal sheet abutting the guide plate surface, the cutting tool is positioned for cutting into the edge of the metal sheet. The cutting tool is able to be moved relative to the guide bar surface to determine a depth of cut.

### BACKGROUND OF THE INVENTION

1. Field of the Present Disclosure

This disclosure relates generally to mechanized cutting tools and more particularly to a hand held tool for cutting into the edges of automotive door skins to enable more efficient removal of such skins from doors.

2. Description of Related Art Including Information Disclosed Under 37 CFR 1.97 and 1.98

Langhans, U.S. Pat. No. 7,028,596, discloses a circular-cutter unit for equipment cutting flat lengths of material and sheet metal in a horizontal plane has upper and a lower circular blades both in planes perpendicular to the horizontal plane and in a longitudinal direction, carried by an upper and lower blade shaft, respectively, which are parallel with the horizontal plane and perpendicular to the longitudinal direction. The two blade shafts are rigidly and rotatably mounted in a common frame. The frame is U-shaped with the upper and lower legs connected by a flat yoke intersecting the horizontal plane at an acute angle. Several cutter units are mounted in a single apparatus and driven by a common drive from which the units can be individually detached for servicing.

Hsieh, U.S. Pat. No. 6,592,307, discloses a planning device for removing weld beads on car sheet metal, which comprises a handle, a cylinder cover and a support frame; the front end of the support frame is mounted with a round milling cutter; the inner side of the round milling cutter is furnished with a guide frame for adjusting the height between the bottom surface of the guide frame and the surface a sheet metal; when the round milling cutter is rotated at a high speed, the weld beads on a car sheet metal will be planed off.

Kolesky, U.S. Pat. No. 5,074,046, discloses a manual sheet metal cutter (10) with a movable upper blade (12B) laterally offset from and integrally formed with a lower movable handle (12A) pivotally connected to, and sandwiched between, a stationary blade member (14) on the offset side of the movable blade (12B) and a stationary handle (16), of which are all pivotally connected together by a single fastener (11) defining a pivot axle. A rearward extension (14A) of the stationary blade (14B) defines an alignment section which bears against a mating alignment portion of an intermediate section (12C) of the movable blade member (12) to maintain the blades (12B, 14B) in correct cutting relationship. The fastener (11) enables pivotal adjustment of the angle of the stationary handle member (16) relative to the stationary blade member (14B), and an arcuate lower edge (14C) of the stationary blade member (14) defines a rocker to facilitate rocking, cutting movement.

Pomikacsek U.S. Pat. No. 4,856,948, discloses a milling device for working, and particularly for trimming the edges, of sheet metal strips, sheet metal plates, and the like. The workpiece is movable in any desired shape or direction in relation to the working position between guide rollers. The milling device has a cutter head which can be turned by a motor. The rotational axis of the cutter head is located approximately parallel to the plane of the workpiece and approximately vertical to the direction of advancement of the device. The device is provided with at least one cutter element provided with a cutting edge inclined at an angle to the normal plane of the cutter head.

Harrison, U.S. Pat. No. 4,549,349, discloses a pair of cutter blades is provided for cutting sheet metal in flat tubular form. The blades are pivotally connected together in scissors-fashion so as to be capable of relative movement between each other. At least one of the blades is formed with a cutting edge comprising a piercing point or region having on each side portions which trail the leading extremity of the piercing point or region considered in the direction of cutting, whereby in operation after initial piercing of the metal to be cut, and on continued cutting, the incision made by the piercing point or region increases away from the pierced region towards the sides of the material being cut. The blades may be operated by means of a piston and cylinder device driving a pair of links connecting the piston to the two blades at positions off-set from the pivotal axis of the two blades.

The related art described above discloses cutting tools adapted for sheet metal cutting. However, the prior art fails to disclose a tool specifically designed for selective depth of cut to accommodate the cutting of door skins off automotive doors. The present disclosure distinguishes over the prior art providing heretofore unknown advantages as described in the following summary.

### BRIEF SUMMARY OF THE INVENTION

This disclosure teaches certain benefits in construction and use which give rise to the objectives described below.

Contemporary automobiles and trucks have sheet metal coverings which are referred to as “skins.” These skins are mounted as the exterior surfaces of doors and certain panels of the vehicle. The terminal periphery of a door skin is formed by folded the edges back by 180°, i.e., back on themselves with the folded portion being on the inside of the skin and therefore not visible when the skin is mounted on a door, for instance. This produces a new peripheral edge on the skin which is more than twice the sheet metal thickness and therefore highly robust. This edge is then a double thickness and is formed with a small space between the two adjacent sheets. The skin is mounted onto the vehicle's door by crimping the edge around the edge of the door frame. This produces a very strong and durable engagement between the skin and the door. However, when a skin is damaged beyond repair, a very common occurrence, it must be replaced. This is commonly accomplished by grinding the edges of the skin down to the door edge so as to cut the skin into two pieces, the outer skin which covers the door, and the inner peripheral bent-over portion. Grinding and other known techniques in common practice have the drawback of being labor intensive, very dirty, relatively slow and subject to inadvertent damage to the vehicle's door edges. Such damage can impede proper mounting of a replacement skin.

When cutting the edge of the skin it is possible to sever the folded over portion of the door skin from the bulk of the door skin without cutting into the edge of the door. However, this cutting operation must be carefully controlled, i.e., the depth of cut must be deep enough to sever the skin's folded-over portion, but not so deep as to cut into the door edge.

The presently described and claimed cutter apparatus has been specifically designed for cutting into an edge of a metal sheet and adjusting a precise depth of cut. A motor drives a cutting tool preferably a rotary file, in axial rotation. A guide plate supports the motor with the cutting tool extending through a hole in the guide plate. A guide bar is fixed to the guide plate and the guide bar presents a guide bar surface which is orthogonal to a guide plate surface so that when the edge of the metal sheet is pressed against the guide bar surface with the metal sheet abutting the guide plate surface, the cutting tool is positioned for cutting into the edge of the metal sheet. The cutting tool is able to be moved relative to the guide bar surface to determine a depth of cut.

A primary objective inherent in the above described apparatus and method of use is to provide advantages not taught by the prior art.

Another objective is to provide a tool adapted for cutting into the edge of a sheet metal part to a selected depth and which can be drawn along the sheet metal part to cut down the edge continuously and uniformally.

Another objective is to provide such a tool wherein metal chips produced by the cutting operation are mostly captured in a hollow receiver of the tool.

Another objective is to provide such a tool that has a motor driven cutting tool and which is conveniently applied to removable of door skins.

Another objective is to provide such a tool that may be adjusted for depth of cut.

Other features and advantages of the present invention will become apparent from the following more detailed description, taken in conjunction with the accompanying drawings, which illustrate, by way of example, the principles of the presently described apparatus and method of its use.

### BRIEF DESCRIPTION OF THE SEVERAL VIEWS OF THE DRAWING(S)

Illustrated in the accompanying drawing(s) is at least one of the best mode embodiments of the present invention In such drawing(s):

FIG. 1 is a perspective view of the presently described apparatus showing a typical use thereof;

FIG. 2 is a perspective frontal elevational view thereof;

FIG. 3 is a perspective frontal elevational view thereof with a chip collection reservoir shown separated from a motor driven portion of the tool;

FIG. 4 is a partial view thereof showing the position of a workpiece being cut;

FIGS. 5 and 6 are top plan views thereof showing a mechanism and means for adjusting depth of cut of the apparatus;

FIG. 7 is a partial elevational view thereof showing a vertical cross sectional view of a portion of a workpiece as inserted into the tool in readiness for cutting; and

FIG. 8 is a partial and cutaway elevational view thereof showing a vertical cross sectional view of a portion of the workpiece as inserted into the tool as it is cut and demonstrating the capture of cutting chips.

### DETAILED DESCRIPTION OF THE INVENTION

The above described drawing figures illustrate the described apparatus and its method of use in at least one of its preferred, best mode embodiment, which is further defined in detail in the following description. Those having ordinary skill in the art may be able to make alterations and modifications to what is described herein without departing from its spirit and scope. Therefore, it must be understood that what is illustrated is set forth only for the purposes of example and that it should not be taken as a limitation in the scope of the present apparatus and method of use.

The edge of door skins are formed when a portion of the sheet metal is folded by 180°. The edge of the door sheet metal is then pressed into the fold of the door skin. When cutting the edge of the skin it is possible to sever the folded over portion of the door skin from the bulk of the door skin without cutting into the edge of the door. However, this cutting operation must be carefully controlled, i.e., the depth of cut must be deep enough to sever the skin folded portion, but not deep enough to cut the door edge.

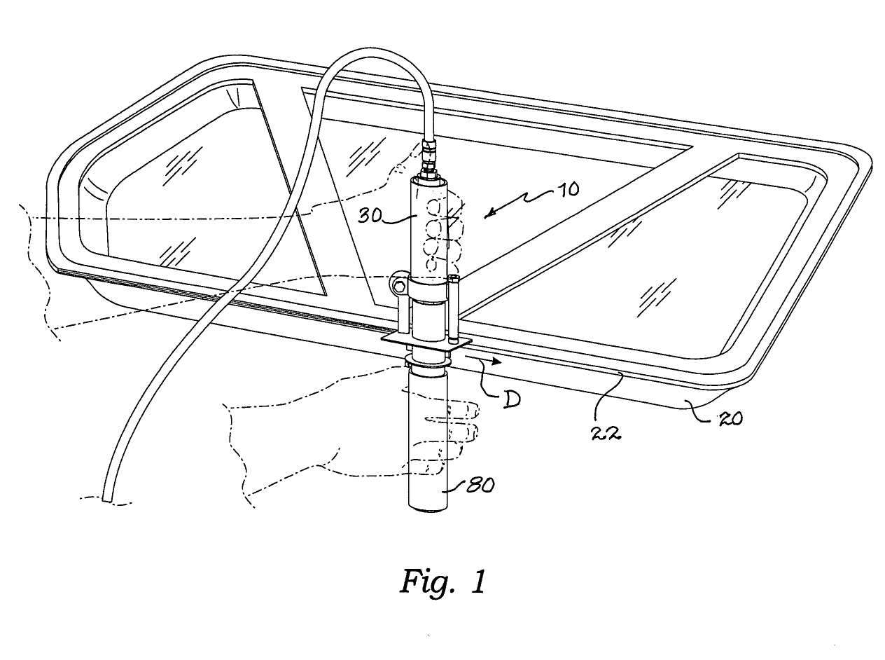

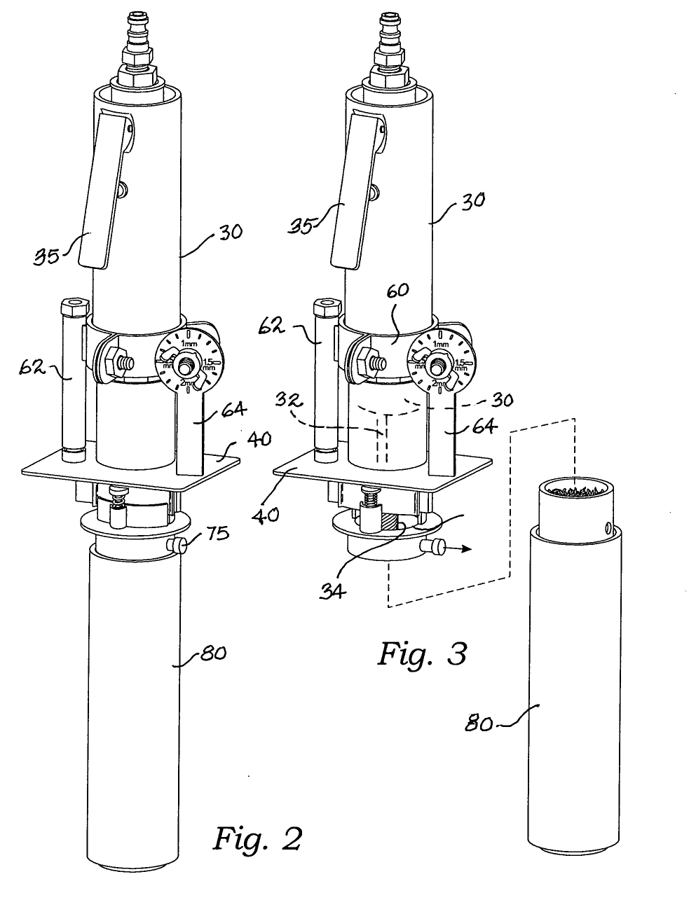

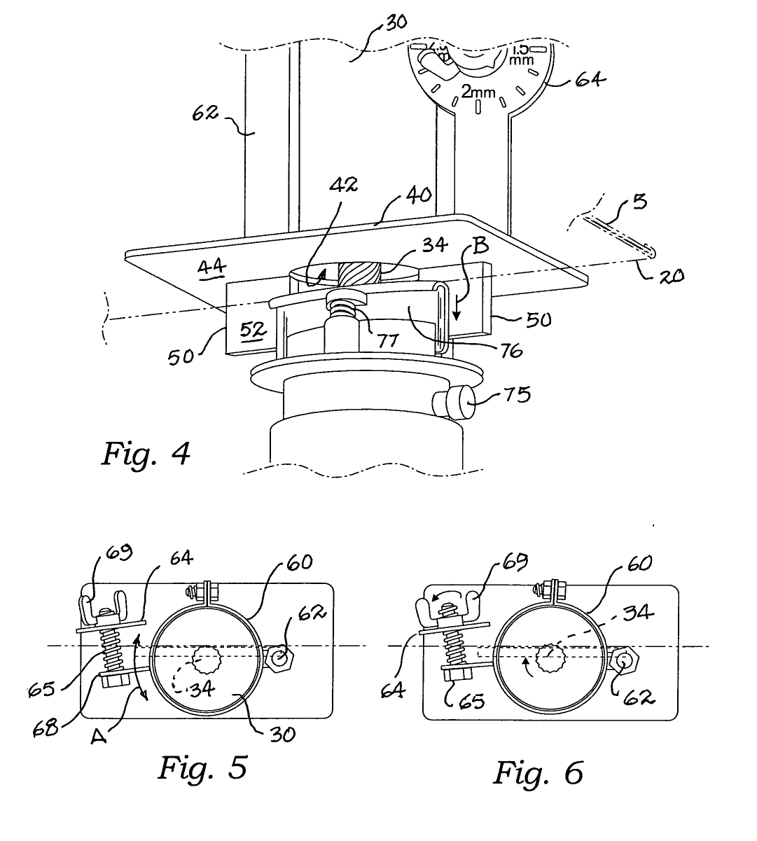

Described now in detail, and as shown in the attached figures, is a mechanized cutter apparatus 10 for cutting into an edge 22 of a metal sheet 20 (see FIG. 1). A motor 30 has a rotationally driven shaft 32, the shaft 32 engaging a cutting tool 34 (FIG. 3) preferably a rotary file. A guide plate 40 supports the motor 30 with the cutting tool 34 extending through a hole 42 in the guide plate 40 (FIG. 4). A guide bar 50 is fixed to the guide plate 40 and the guide bar 50 presents a guide bar surface 52 which is orthogonal to a guide plate surface 44 of the guide plate 40. When the edge 22 of the metal sheet 20 is pressed against the guide bar surface 52 with the metal sheet 20 abutting the guide plate surface 44, the cutting tool 34 is positioned for cutting into the edge 22 of the metal sheet 20.

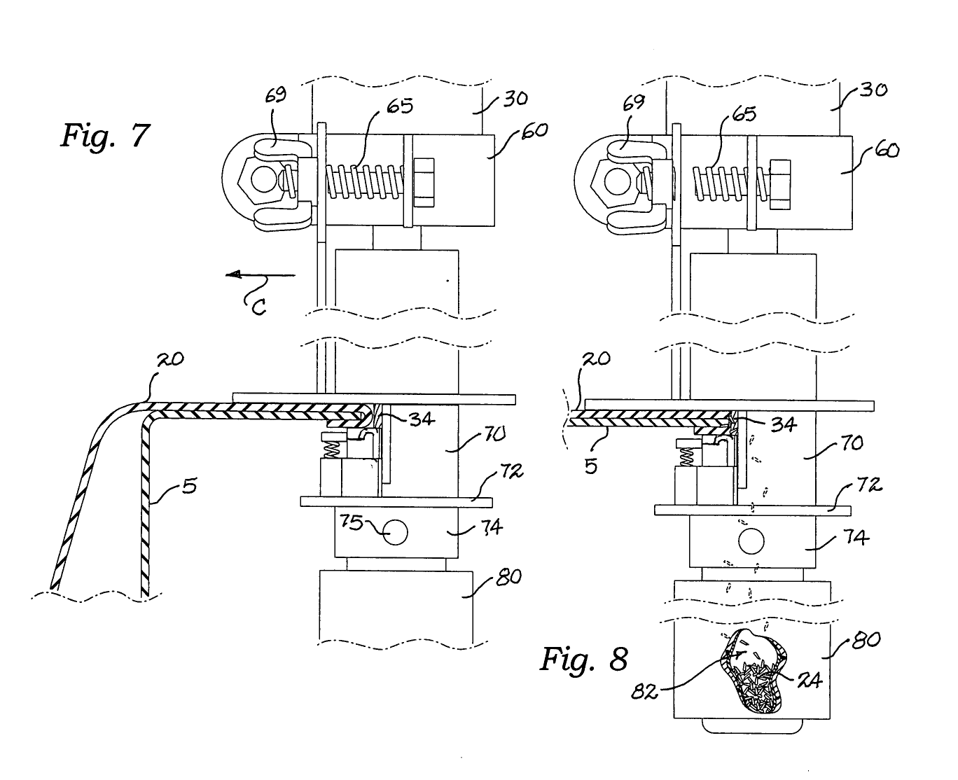

An adjustable clamp 60 is held in a displaced position with respect to the guide plate 40, the clamp 60 engaging the motor 30 to secure it in a fixed position relative to the guide plate 40, and thereby securing the cutting tool 34 at a selected position relative to the hole 42 and especially the guide bar surface 52. The cutting tool 34 extends through the hole 42 as best seen in FIG. 4. The adjustable clamp 60 is pivotally mounted to a turret 62 which is fixed to the guide plate 40 and about which the clamp 60 is therefore able to rotate (see arrow “A” in FIG. 5) in a plane parallel to, and displaced from, the guide plate 40. Clamp 60 is engaged with a calibrated dial 64 which is also fixed to the guide plate 40 and extends away therefrom in a spaced-apart and parallel position to the turret 62 as shown in the figures. An adjustment screw 65 is engaged with the calibrated dial 64 as well as an ear portion 68 of the clamp 60. This enables, by rotation of wing nut 69, the clamp 60 and motor 30 to be rotated in an arc centered on the turret 62, again, as shown by arrow “A” in FIG. 5. When the motor 30 is moved along this arc “A”, tool 34 is moved into a selected position with respect to guide bar surface 52 so as to determine a depth of cut, i.e., the cutting surface of tool 34 breaks the plane defined by the guide bar surface 52, in the direction toward the metal sheet workpiece edge 22 by an amount equal to the desired depth of cut. This means that when the edge 22 to be cut is abutted against the guide bar surface 52, the tool 34 is able to cut into it by the selected depth. This depth is critically important when cutting into the edges of door skins since it is desired to sever the door skin but not cut into the door edge. The relationships are best seen in FIGS. 7 and 8, where in FIG. 7, the edge 22 has been brought into contact with the cutting tool 34 but is therefore not in contact with guide bar surface 52. In FIG. 8, the cutting tool has cut into edge 22 which brings edge 22 on the opposite side visible in FIG. 8 into contact with guide bar surface 52. Contact between edge 22 and surface 52 determines depth of cut. As can be seen in FIG. 7, when cutting into the edge of a door skin, one wishes to cut deep enough to sever the skin but not deep enough to cut into the edge of the door 5.

A housing 70 is integral with and extends from the guide plate 40 in opposition to the motor 30. The housing 70 is further integral with a flange 72 and a nipple 74. The nipple 74 removably engages a handle 80 providing interior therein, a storage space 82 for receiving chips 24 cut from the metal sheet 20. The nipple 74 provides a latch 75 which engages the handle 80 so as to hold the handle 80 to the nipple 74. Both the housing 70, the nipple 74 and the handle 80 are essentially hollow so that metal chips 24 chipped away from the metal sheet 20 as it is cut are captured and fall into the storage space 82 for later disposal by removing the handle 80 from the nipple 74 using the latch 75.

Mounted on the housing 70 is a sliding door 76 positioned in parallel with the guide bar 50. The sliding door 76 has a bias relationship with a biasing element 77, preferably a coil spring which is mounted and positioned to move the sliding door 76 toward the guide plate surface 44. Therefore, the sliding door 76 is able to prevent cut chips 24 from flying out of the apparatus during cutting operations. These chips 24 are captured and stored within the handle 80.

In operation, the wing nut 69 is rotated to select a desired depth of duct as shown on the calibrated dial 64. Next, the sliding door 76 is pressed downwardly against spring 77 in the direction shown by arrow “B” in FIG. 4 and the workpiece is inserted into the apparatus as shown in FIG. 7. Next, with manual pressure applied to the apparatus 10 in the direction shown in FIG. 4 by arrow “C,” the motor switch lever 35 is depressed so as to energize the motor 30 by electrical power or compressed air. The apparatus is moved along the edge 22 of the workpiece in the direction into the plane of the illustrations shown in FIGS. 7 and 8, or as shown by arrow “D” in FIG. 1. During cutting, as the apparatus is moved along the workpiece, pressure is continually applied to the apparatus to maintain surface 44 against workpiece 20 and edge 22 against surface 52.

The enablements described in detail above are considered novel over the prior art of record and are considered critical to the operation of at least one aspect of the apparatus and its method of use and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

What is claimed is:

1. A mechanized cutter apparatus for cutting into a sheet metal workpiece edge, the apparatus comprising: a motor having a rotationally driven shaft, the shaft engaging a cutting tool; a guide plate supporting the motor thereon with the cutting tool extending through a hole therein; a guide bar fixed to the guide plate, the guide bar presenting a guide bar surface orthogonal to a guide plate surface of the guide plate; the position of the cutting tool being selectively adjustable relative to the guide bar surface thereby determining a depth of cut into the workpiece edge, whereby with the guide bar surface abutting the edge of the metal sheet, and with the metal sheet abutting the guide plate surface, the cutting tool is able to cut into the sheet metal workpiece edge.

2. The apparatus of claim 1 wherein the cutting tool is a rotary file.

3. The apparatus of claim 1 further comprising an adjustable clamp fixed to the guide plate, the adjustable clamp securing the motor.

4. The apparatus of claim 3 wherein the adjustable clamp is enabled for moving the motor relative to the guide plate hole thereby positioning the cutting tool relative to the guide bar surface to establish the depth of cut of the cutting tool into the workpiece edge.

5. The apparatus of claim 1 further comprising a housing integral with and extending from the guide plate in opposition to the motor.

6. The apparatus of claim 5 wherein the housing provides a nipple removably engaging a handle, the handle providing a storage space for receiving chips cut from the metal sheet workpiece edge.

7. The apparatus of claim 6 wherein the nipple provides a latch engaging the handle.

8. The apparatus of claim 1 wherein the fixture provides a sliding door positioned in parallel with the guide bar surface, the sliding door biased by a biasing element to move the sliding door toward the guide plate surface.

9. The apparatus of claim 8 wherein the biasing element is a spring.

10. The apparatus of claim 4 wherein the adjustable clamp provides a calibrated dial and an adjustment screw engaged with a threaded shaft, the position of the screw relative to the dial determining and indicating the depth of cut.
